(19) United States
(12) Patent Application Publication
(10) Pub. No.: US 2008/0310670 A1
(43) Pub. Date: Dec. 18, 2008

(54) ELECTROACOUSTIC TRANSDUCER AND MAGNETIC CIRCUIT UNIT

(76) Inventor: Toshio Itakura, Tsuru-shi (JP)

Correspondence Address: BRINKS HOFER GILSON & LIONE, P.O. BOX 10395, CHICAGO, IL, 60610, US

(21) Appl. No.: 12/140,800

(22) Filed: Jun. 17, 2008

(30) Foreign Application Priority Data
Jun. 18, 2007 (JP) JP2007-159850

(51) Int. Cl. H04R 1/00

(52) U.S. Cl. 381/412

(57) ABSTRACT

An electroacoustic transducer includes a magnetic circuit unit having a yoke, a magnet secured to the top of the bottom wall portion of the yoke, and a top plate secured to the top of the magnet. An annular magnetic gap is defined between the peripheral wall portion of the yoke and the top plate. A voice coil is disposed in the magnetic gap of the magnetic circuit unit. A diaphragm is secured to the voice coil, and a space is formed between the diaphragm and the top plate. The outside of the transducer and the space are communicated with each other through mutually communicated through-holes formed in the bottom wall portion of the yoke, the magnet and the top plate, respectively. The through-hole of the yoke has an inner diameter larger than the inner diameter of the through-hole of the magnet. A filter is disposed in the through-hole of the yoke and bonded to the magnet, thereby preventing entry of contamination into the space from the outside of the electroacoustic transducer.

This application claims priority under 35 U.S.C. §119 to Japanese Patent application No. JP2007-159850 filed on Jun. 18, 2007, the entire contents of which are hereby incorporated by reference.

### TECHNICAL FIELD

The present invention relates to electroacoustic transducers for use in acoustic devices and information communication devices. More particularly, the present invention relates to a thin speaker as an electroacoustic transducer that is designed to prevent entry of contamination such as dust through a through-hole for air communication between the inside and outside of the speaker.

### RELATED CONVENTIONAL ART

Recently, small, thin and high-performance electrodynamic speakers have been widely used as electroacoustic transducers of mobile communication devices such as mobile phones (for example, see Japanese Patent Application Publication No. 2004-356833). FIG. 3 is a sectional view showing a conventional speaker. One example of such conventional speakers will be explained below with reference to FIG. 3.

As shown in FIG. 3, a conventional speaker has a magnetized magnet 1, a top plate 2, a yoke 3, a frame 6 bonded to the yoke 3, a diaphragm 7 bonded to the peripheral edge of the frame 6, and a voice coil 8 bonded to the diaphragm 7. The magnet 1, the top plate 2 and the yoke 3 constitute in combination a magnetic circuit unit 4. The voice coil 8 is inserted and set in a magnetic gap 5 in the magnetic circuit unit 4. When a sound signal is input to the voice coil 8 of the speaker, the diaphragm 7 vibrates to generate sound.

In the above-described conventional speaker, the magnet 1, the top plate 2 and the yoke 3 are generally provided with through-holes 1a, 2a and 3a at their substantially central portions, respectively, to allow air to flow into and out of the speaker because the vibrating characteristics of the diaphragm 7 will be degraded to a considerable extent if there is a large difference in air pressure between the inside and outside of the speaker. In this regard, however, if contamination such as dust enters the speaker through the through-holes 1a, 2a and 3a, there may be an adverse effect on the magnetic gap 5, which is narrow in width. Therefore, a dustproof filter 9 is provided in order to prevent entry of such contamination. One known example of the filter 9 is a mesh-like cloth having a diameter larger than a diameter of the through-hole 3a of the yoke 3, and the filter 9 is bonded with an adhesive or the like to a lower surface of the yoke 3 that faces away from the magnet 1, i.e. to the bottom of the yoke 3, covering the through-hole 3a of the yoke 3.

FIG. 4 shows an example in which a filter 9A is provided at a position different from the above. As shown in FIG. 4, the filter 9A is a mesh-like cloth disposed inside the diaphragm 7 and having a diameter larger than a diameter of the through-hole 2a of the top plate 2. The filter 9A is bonded with an adhesive or the like to an upper surface of the top plate 2 that faces away from the magnet 1, i.e. to the top of the top plate 2, and the filter 9A covers the through-hole 2a of the top plate 2. The arrangement of the rest of the speaker shown in FIG. 4 is the same as the speaker shown in FIG. 3.

The magnetic circuit unit 4 of the speaker according to the conventional art has a structure in which the magnet 1 is stacked on the top of the yoke 3 and the top plate 2 is stacked on the top of the magnet 1, as has been stated above. Accordingly, it is necessary in order to achieve a thinner profile to reduce the thickness of each component of the magnetic circuit unit 4. In the conventional speaker shown in FIG. 3, however, the dustproof filter 9 is bonded to the bottom of the yoke 3, i.e. the outer side thereof, in order to prevent entry of contamination such as dust through the through-holes 1a, 2a and 3a for air communication. Therefore, the overall thickness of the speaker increases by an amount corresponding to the thickness of the filter 9. Thus, it is difficult to achieve a thinner speaker as an electroacoustic transducer. Further, because the filter 9 projects from the bottom of the yoke 3, it may be dislodged or damaged if the filter 9 contacts an external physical object.

In the conventional speaker shown in FIG. 4, the filter 9A is disposed inside the diaphragm 7 and hence cannot contact any external physical object. There is therefore no possibility of the filter 9A being dislodged or damaged. It is, however, necessary to ensure a predetermined clearance a between the diaphragm 7 and the filter 9A. Accordingly, the overall thickness of the speaker increases by an amount corresponding to the thickness of the filter 9A, which makes it difficult to achieve a thinner speaker as an electroacoustic transducer.

### SUMMARY OF THE INVENTION

The present invention has been made in view of the above-described problems. Accordingly, an object of the present invention is to provide a thin magnetic circuit unit capable of inexpensively preventing entry of contamination through a through-hole for air communication. Another object of the present invention is to provide a thin electroacoustic transducer using the magnetic circuit unit of the present invention.

According to the present invention, the magnetic circuit unit comprises a yoke having a flat surface and, a magnet and a top plate stacked on the flat surface of the yoke in that order. An annular magnetic gap is defined around the peripheral edge surface of the top plate. The magnetic circuit unit further includes mutually communicated through-holes formed in a central portion of the yoke, the magnet and the top plate, respectively. A filter is disposed in at least one of the through-holes.

In this magnetic circuit unit, the filter is installed in at least one of the through-holes. Therefore, the height of the magnetic circuit unit can be made lower than that of the magnetic circuit unit in the above-described conventional art.

Specifically, the magnetic circuit unit may be arranged as follows. The diameter of the through-hole of the yoke or that of the top plate is made larger than the diameter of the through-hole of the magnet, and the filter is disposed in the through-hole of the yoke or the top plate and bonded to the magnet.

The thickness of the filter may be set substantially equal to or smaller than the thickness of the yoke or the top plate.

Further, an annular second magnet may be provided on the peripheral edge of the flat surface of the yoke and a second top plate secured to the top of the second magnet. In this case, the magnetic gap is formed between the top plate and the second top plate.

The yoke may have a cylindrical peripheral wall portion extending from the peripheral edge of the flat surface and the cylindrical peripheral wall surrounds the first magnet. In this case, the magnetic gap is formed between the top plate and the inner surface of the cylindrical peripheral wall of the yoke.

In addition, the present invention provides an electroacoustic transducer having the above-described magnetic circuit unit.

Embodiments of the present invention will be explained below with reference to the accompanying drawings.

### BRIEF DESCRIPTION OF THE DRAWINGS

FIG. 1a is a sectional view of a speaker according to a first embodiment of the present invention.

FIG. 1b is an enlarged sectional view of a part of a magnetic circuit unit of the speaker shown in FIG. 1a.

FIG. 2a is a sectional view of a speaker according to a second embodiment of the present invention.

FIG. 2b is an enlarged sectional view of a part of a magnetic circuit unit of the speaker shown in FIG. 2a.

FIG. 3 is a sectional view of a speaker according to a conventional art.

FIG. 4 is a sectional view of a speaker according to another conventional art.

FIG. 5 is sectional view of a speaker according to a second embodiment of the present invention.

### DETAILED DESCRIPTION OF THE PREFERRED EMBODIMENTS

### First Embodiment

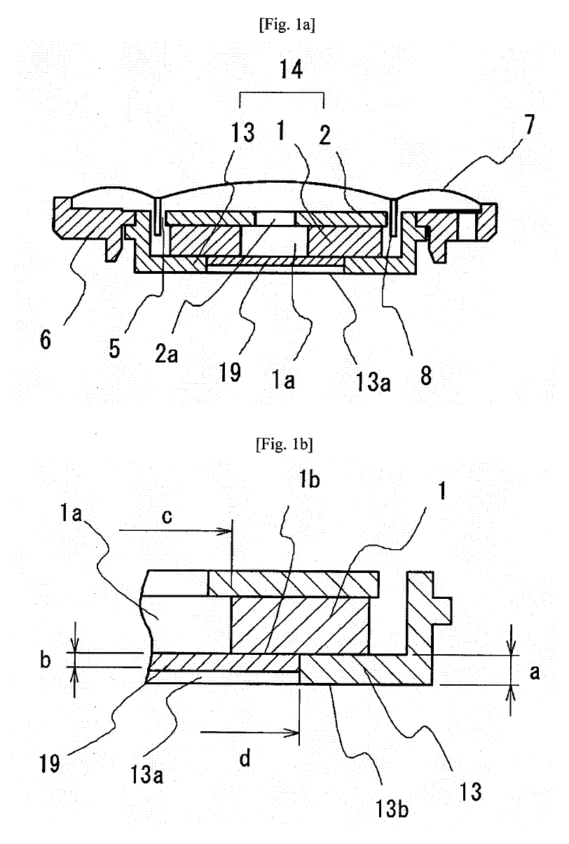

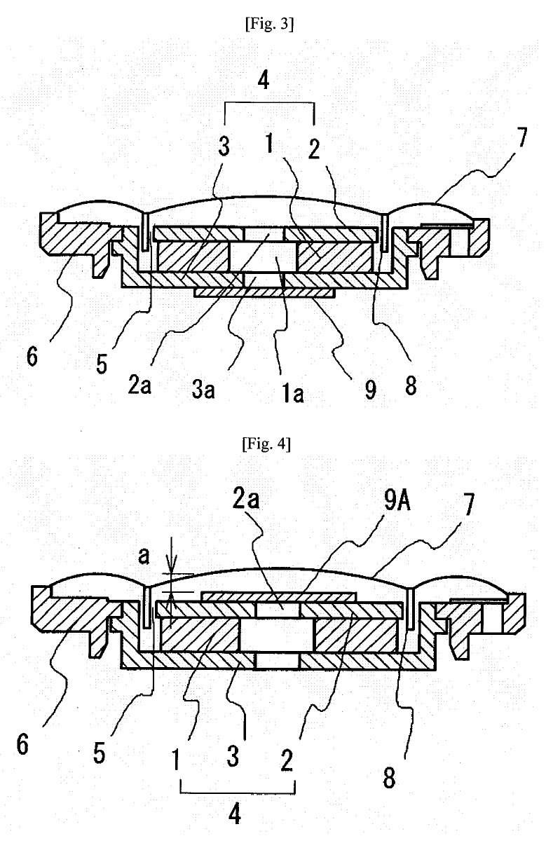

FIGS. 1a and 1b show a speaker as an electroacoustic transducer according to a first embodiment of the present invention. The speaker of this embodiment differs from the above-described conventional speakers in that a mesh-like filter is disposed inside a through-hole for air communication provided in the bottom of a yoke of a magnetic circuit unit and the filter covers a through-hole for air communication provided in a magnet. The arrangement of the rest of the speaker is the same as the conventional speakers shown in FIGS. 3 and 4. The same constituent elements of the speaker as those of the conventional ones are denoted by the same reference numerals as used in FIGS. 3 and 4.

The speaker of this embodiment has a magnetic circuit unit 14 including a magnet 1, a top plate 2 and a yoke 13 having a flat bottom wall portion on which the magnet 1 is mounted. The yoke 13 further has a peripheral wall portion that forms a magnetic gap 5 between the same and the peripheral edge surface of the top plate 2. The speaker further has a voice coil 8 disposed in the magnetic gap 5 and a diaphragm 7 joined to and driven by the voice coil 8. For air communication between the inside and outside of the speaker, through-holes 1a, 2a and 13a are provided in respective centers of the magnet 1, the top plate 2 and the bottom wall portion of the yoke 13.

The diameter d of the through-hole 13a of the yoke 13 is set larger than the diameter c of the through-hole 1a of the magnet 1. A mesh-like filter 19 is disposed in the through-hole 13a of the yoke 13. The filter 19 comprises a mesh-like cloth. The diameter of the filter 19 is set larger than the diameter c of the through-hole 1a of the magnet 1 and equal to or smaller than the diameter of the through-hole 13a of the yoke 13. The filter 19 is disposed in the through-hole 13a of the yoke 13 and bonded with an adhesive or the like to a surface 1b of the magnet 1 around the through-hole 1a, and the filter 19 covers the through-hole 1a of the magnet 1. It is preferable from the viewpoint of minimizing the thickness of the speaker to set the thickness b of the filter 19 substantially equal to or smaller than the thickness a of the yoke 13.

Thus, according to this embodiment, the mesh-like filter 19 is disposed in the through-hole 13a provided in the center of the of the yoke 13 of the magnetic circuit unit 14 and the filter 19 covers the air communication through-hole 1a of the magnet 1, preventing entry of contamination such as dust through the through-holes 1a, 2a and 13a from the outside of the speaker. Consequently, it is possible to provide a thin speaker as an electroacoustic transducer that is excellent in dustproof performance and superior in reliability.

Further, because the filter 19 is disposed inside the through-hole 13a of the yoke 13, it cannot contact any external physical object. There is therefore no possibility of the filter 19 being dislodged or damaged.

### Second Embodiment

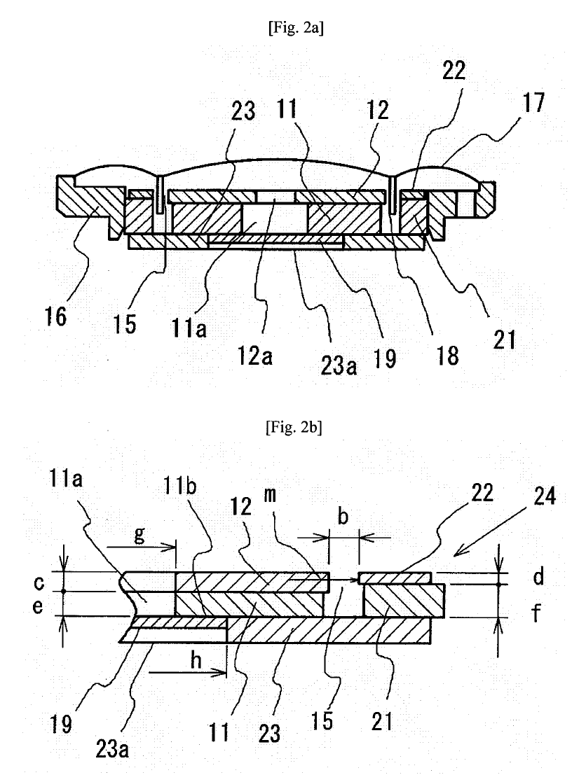

FIGS. 2a and 2b show a speaker according to a second embodiment of the present invention. The speaker of this embodiment is the same as the above-described first embodiment, except that the yoke comprises a flat bottom wall member 23, a second magnet 21 provided along the peripheral edge of the flat top of the bottom wall member 23, and a second top plate 22 disposed on the top of the second magnet 21, and that a magnetic gap 5 is formed between a first top plate 12 on a first magnet 11 and the second top plate 22.

The thickness f of the second magnet 21 is set larger than the thickness e of the first magnet 11. The thickness d of the second top plate 22 is set smaller than the thickness c of the first top plate 12. When the first and second top plates 12 and 22 are stacked on the first and second magnets 11 and 21, respectively, their respective tops are substantially flush with each other.

The thicknesses e and f of the first and second magnets 11 and 21 are each set smaller than the air gap distance b of the magnetic gap 5. The thickness c of the first top plate 12 is set larger than the thickness d of the second top plate 22.

In consequence of the above-described arrangement, an outlet area of the magnetic flux becomes larger than an inlet area of the magnetic flux. Accordingly, a magnetic field of high magnetic flux density m acts on the magnetic gap 5 from the first top plate 12 to the second top plate 22. Thus, the magnetic flux density m acting on the air gap of the magnetic gap 5 increases.

### Third Embodiment

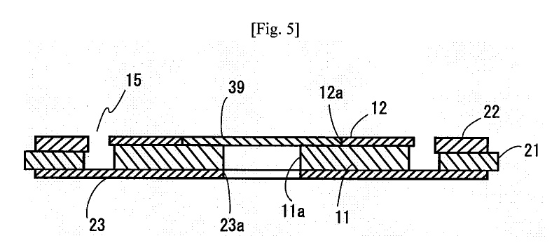

FIG. 5 shows a magnetic circuit unit of a speaker according to a third embodiment of the present invention, which is a modification of the magnetic circuit unit of the second embodiment. The basic structure of the magnetic circuit unit in this embodiment is the same as that shown in FIG. 2a. In FIG. 5, the same constituent elements as those of the second embodiment are denoted by the same reference numerals as used in FIG. 2a. The magnetic circuit unit of this embodiment differs from that shown in FIG. 2a in that a filter 39 is set not in the through-hole 23a of the yoke 23 but in the through-hole 12a of the first top plate 12 that is made larger in diameter than the through-hole 11a of the first magnet 11, and bonded to the top of the first magnet 11.

Although some embodiments of the present invention have been described above, it should be noted that the present invention is not necessarily limited to the foregoing embodiments. For example, although the present invention is applied to speakers in the foregoing embodiments, it is also applicable to other electroacoustic transducers such as microphones.

1. An electroacoustic transducer comprising:
a magnetic circuit unit including a yoke having a flat surface, and a magnet and a top plate stacked on the flat surface of the yoke in that order, the magnetic circuit unit having an annular magnetic gap defined around a peripheral edge surface of the top plate;
a voice coil disposed to extend into the magnetic gap;
a diaphragm to which the voice coil is secured; and
a space formed between the diaphragm and the top plate;
the yoke, the magnet, and the top plate having respectively through-holes that mutually communicate, and the space and an outside of the electroacoustic transducer communicated with each other through the through-holes,
in which the electroacoustic transducer further comprises a filter disposed in at least one of the through-holes to prevent entry of contamination into the space from the outside of the electroacoustic transducer.

2. The electroacoustic transducer of claim 1, wherein the through-hole of the yoke has a diameter larger than a diameter of the through-hole of the magnet;
the filter being disposed in the through-hole of the yoke and bonded to the magnet.

3. The electroacoustic transducer of claim 1, wherein the through-hole of the top plate has a diameter larger than a diameter of the through-hole of the magnet;
the filter being disposed in the through-hole of the top plate and bonded to the magnet.

4. The electroacoustic transducer of claim 2, wherein the filter has a thickness substantially equal to or smaller than a thickness of the yoke.

5. The electroacoustic transducer of claim 3, wherein the filter has a thickness substantially equal to or smaller than a thickness of the top plate.

6. The electroacoustic transducer of claim 1, wherein the yoke further comprises a cylindrical peripheral wall portion integrally formed with and extending from a peripheral edge of the flat surface, and the cylindrical peripheral wall surrounds the magnet and the top plate;
the magnetic gap being formed between an outer peripheral surface of the top plate and an inner peripheral surface of the cylindrical peripheral wall of the yoke.

7. The electroacoustic transducer of claim 1 further comprising,
a second magnet provided on the flat surface of the yoke along a peripheral edge of the flat surface; and
a second top plate secured to a top of the second magnet;
the magnetic gap being formed between the top plate and the second top plate

8. The electroacoustic transducer of claim 2, further comprising,
a second magnet provided on the flat surface of the yoke along a peripheral edge of the flat surface; and
a second top plate secured to a top of the second magnet;
the magnetic gap being formed between the top plate and the second top plate

9. The electroacoustic transducer of claim 3, further comprising,
a second magnet provided on the flat surface of the yoke along a peripheral edge of the flat surface; and
a second top plate secured to a top of the second magnet;
the magnetic gap being formed between the top plate and the second top plate

10. The electroacoustic transducer of claim 4, further comprising,
a second magnet provided on the flat surface of the yoke along a peripheral edge of the flat surface; and
a second top plate secured to a top of the second magnet;
the magnetic gap being formed between the top plate and the second top plate

11. The electroacoustic transducer of claim 5, further comprising,
a second magnet provided on the flat surface of the yoke along a peripheral edge of the flat surface; and
a second top plate secured to a top of the second magnet;
the magnetic gap being formed between the top plate and the second top plate

12. A magnetic circuit unit comprising:
a yoke having a flat surface;
a magnet secured to the flat surface of the yoke; and
a top plate secured to a top of the magnet;
an annular magnetic gap defined around a peripheral edge surface of the top plate; and
mutually communicated through-holes formed in the yoke, the magnet and the top plate, respectively; and
a filter disposed in at least one of the through-holes.

13. The magnetic circuit unit of claim 12, wherein the through-hole of the yoke has a diameter larger than a diameter of the through-hole of the magnet;
the filter being disposed in the through-hole of the yoke and bonded to the magnet.

14. The magnetic circuit unit of claim 12, wherein the through-hole of the top plate has a diameter larger than a diameter of the through-hole of the magnet;
the filter being disposed in the through-hole of the top plate and bonded to the magnet.

15. The magnetic circuit unit of claim 13, wherein the filter has a thickness substantially equal to or smaller than a thickness of the yoke.

16. The magnetic circuit unit of claim 14, wherein the filter has a thickness substantially equal to or smaller than a thickness of the top plate.

17. The magnetic circuit unit of claim 12, further comprising,
a second magnet provided on the flat surface of the yoke along a peripheral edge of the flat surface; and
a second top plate secured to a top of the second magnet;
the magnetic gap being formed between the top plate and the second top plate

18. The magnetic circuit unit of claim 12, further comprising,
a second magnet provided on the flat surface of the yoke along a peripheral edge of the flat surface; and
a second top plate secured to a top of the second magnet;
the magnetic gap being formed between the top plate and the second top plate

19. The magnetic circuit unit of claim 13, further comprising,
a second magnet provided on the flat surface of the yoke along a peripheral edge of the flat surface; and
a second top plate secured to a top of the second magnet;
the magnetic gap being formed between the top plate and the second top plate

20. The magnetic circuit unit of claim 14, further comprising,
a second magnet provided on the flat surface of the yoke along a peripheral edge of the flat surface; and
a second top plate secured to a top of the second magnet;
the magnetic gap being formed between the top plate and the second top plate
